(19) United States
(12) Patent Application Publication
(10) Pub. No.: US 2005/0083867 A1
(43) Pub. Date: Apr. 21, 2005

(54) Control unit and method for controlling a receiver unit

(76) Inventor: Kai Dombrowski, Frankfurt (Oder) (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/496,994

(22) PCT Filed: Dec. 2, 2002
(86) PCT No.: PCT/EP02/13617

(30) Foreign Application Priority Data
Nov. 30, 2001 (DE) 101 60 510.2

(51) Int. Cl. G08C 17/00

(52) U.S. Cl. 370/311

(57) ABSTRACT

There is provided a control unit 5 for breaking off processing of a data packet which is coming into a communication unit. The control unit 5 includes a comparison device for comparing the target address of the data packet to at least one predetermined address. The control unit 5 breaks off processing of the data packet by at least partially switching off the receiving unit 1 as soon as it establishes that the target address is not in conformity with the predetermined address. If in contrast it establishes conformity of the two addresses—in other words the data packet is intended for the receiving communication unit—it does not break off processing and the entire data packet is properly received. Comparison of the addresses is effected before the complete data packet is processed.

The present invention concerns a control unit and a method of controlling a receiving unit for wireless data transmission as well as a communication unit for wireless communication.

The wireless transmission of data packets is frequently implemented in accordance with standard protocols, such as for example the IEEE 802.11a standard. Those protocols generally comprise various protocol levels, wherein each level assumes a given function in terms of data transmission. Thus for example in the IEEE 802.11a standard the bottom two protocol levels are the physical level for establishing the hardware parameters of transmission and the MAC level (Medium Access Control) for controlling access to the transmission medium.

The physical level establishes the hardware parameters of the transmission, for example the transmission speed, the transmitting power, the transmission medium, the interfaces and so forth. For that purpose the transmitting/receiving unit, besides the transmitter/receiver, includes further components, for example a Viterbi decoder and a device for fast Fourier transformation, referred to for brevity hereinafter as the FFT device (East Fourier Transformation).

The MAC unit 3 represents the next higher level in the IEEE 802.11a standard, following the physical level. It is a protocol level which is responsible for the order remaining observed when using the common transmission medium. For that purpose it includes a device for executing the so-called protocol for multiple access with collision avoidance, referred to briefly as the CSMA/CA protocol (carrier sense multiple access with collision avoidance) and a device for executing cyclic block checking, referred to briefly as CRC (cyclic redundancy check)—a procedure for checking data packets for transmission errors.

Upon the reception of a data packet, firstly the tasks of the physical level and the MAC level are performed before further processing of the received data packet is implemented. The performance of those tasks requires power consumption levels of 1-2 W, in communication units in accordance with the state of the art. As wireless communication units are often mobile communication units with limited power reserves, it is desirable to reduce the power consumption of the communication units.

An aim of the present invention is to provide a control unit and a method of controlling a receiving unit for wireless data transmission, with which the power consumption of the communication unit can be reduced. Another aim of the present invention is to provide a communication unit for wireless communication, which enjoys reduced power consumption in comparison with communication units in accordance with the state of the art.

The first aim is achieved by a control unit as set forth in claim 1 and a method as set forth in claim 16. The second aim is achieved by a communication unit as set forth in claim 11. The appendant claims set forth further configurations of the present invention.

The invention is based on the following consideration:

A transmitted data packet contains at least one address which identifies that communication unit for which the data packet is intended. That address is referred to hereinafter as the target address. If the data packet is directed to a plurality of communication units it may also contain a plurality of target addresses. In the IEEE 802.11a standard (as also in other standards), the receiving communication unit checks whether the target address of the received data packet is in conformity with its own address, that is to say whether it is indeed intended as the receiver of the data packet. That checking operation is only effected in the MAC level after the data packet has been completely processed by the receiving unit. In other words, all data packets which are sent within the receiving region of a wireless communication unit are firstly completely received by the communication unit, independently of their addressing, and processed for example by a Viterbi decoder, before the communication unit in the MAC level of the protocol checks whether the data packet is in fact intended for it. If that is not the case, the data packet is rejected, that is to say erased again—reception of the data packet was in vain. In networks with a plurality of wireless communication units however it frequently happens that a communication unit receives a data packet which is not intended for it at all and which accordingly is rejected again after complete reception. That fact is particularly serious in the case of networks with a large number of communication units.

The address of the communication unit for which the data packet is intended, that is to say the target address, is to be found at least in the fifth to tenth byte of the received data packet and any further address which is possibly to be evaluated is in the seventeenth to twenty-second byte. If now the communication unit compares the target address to its address or possibly to a list of addresses which are valid for it, it knows from the first deviation of the target address from all its addresses the data packet is not intended for it, and it can break off processing of the data packet, for example in the Viterbi decoder. It is particularly desirable if it is not just processing by those components of the receiving unit which are connected downstream of the receiver, that is broken off, but reception of the data packet itself, that is to say processing by the receiver, is already broken off. If the data packet is put into intermediate storage prior to processing by the downstream-connected components, in the receiving unit, the reference to breaking off processing also means that the data packet, after intermediate storage, is in no way first forwarded for processing to further components of the receiving unit, for example the Viterbi decoder.

In accordance with the invention, for breaking off processing, there is provided a control unit with a comparison device for comparing the target address to at least one predetermined address. The control unit controls the receiver of the communication device and breaks off processing by a procedure whereby it at least partially switches off the receiving unit as soon as it establishes that the target address is not in conformity with the predetermined address. In that respect switching off is used to denote any form of power-saving deactivation and partially switching off is used to denote switching off or preventing activity in at least one component of the receiving unit, for example the Viterbi decoder. That can all already occur before the complete data packet is processed by the receiving unit, in particular before it is completely received. If in contrast it is found that both addresses are in conformity—in other words the data packet is intended for the receiving communication unit—the control unit does not break off processing; the entire data packet is processed in the proper fashion by the receiving unit. Breaking off the processing procedure makes it possible to achieve a power saving for the communication unit.

As in most cases the target address is received with the reception of the tenth byte and at the latest with the reception of the twenty-second byte, the control unit, after reception of the tenth or at least the twenty-second byte, is in a position to break off the processing if the target address is not in conformity with the predetermined address. Usually the length of a data packet is markedly greater than 10 bytes and can be up to 2346 bytes. Therefore, only the first 10 bytes or at a maximum 22 bytes have to be processed in order to be able to decide whether processing is to be continued. If the received data of the data packet are forwarded by the receiver of the receiving unit to a processing component in the receiving unit, without putting them into intermediate storage beforehand, then in general scarcely more than the first 10 bytes have to be received before the decision can be made about breaking off processing. If processing is broken off, that is to say if the target address and the predetermined address do not coincide, then one, a plurality of or all components of the receiving unit can be switched off, until the next transmission. That markedly reduces the power consumption of the receiving unit.

The comparison of the target address with the predetermined address can take place either on the basis of the completely received address or in bit-wise manner, for example during reception. For comparison of the complete addresses the comparison device includes for example first and second registers for storing the target address and the predetermined address respectively and a comparator for comparing the contents of the two registers. For bit-wise comparison the comparison device includes for example a one-bit register as the first register and as an additional component an access unit for access to the content of individual memory cells of the second register. Bit-wise comparison affords the advantage over comparison of the complete addresses that processing can frequently already be broken off before the entire address has been received. On the other hand however it requires a somewhat more complicated and expensive design for the comparison device.

The operation of switching on the switched-off components, that is to say reactivating the deactivated components, can be effected by the receiver as soon as it establishes the input of the next data packet. It will be noted however that this procedure is only possible when the receiver itself is not switched off.

In an alternative configuration of the invention the receiver can also be switched off (deactivated), in which case the operation of switching on again is then effected by the control unit after elapse of a given waiting time. The waiting time is determined having regard to the transmission rate with which the data packet is transmitted, and the length of the data packet. In addition, apparatus-specific parameters as well as the time between the transmission of two successive data packets can also be involved in determining the waiting time. If the control unit only switches on the receiver again after the expiry of the waiting time, the other components are switched on again upon reception of the next data packet by the receiver. Alternatively however the control unit can also switch on all switched-off components again, after the expiry of the waiting time. The possibility of also switching off the receiver means that the power consumption of the receiving unit can be further reduced.

Instead of a waiting time which is common for all switched-off (deactivated) components, it is also possible to calculate an individual waiting time for each component, in particular having regard to the respective apparatus-specific parameters. If the control unit is intended to control switching on all components (reactivating the components), the individual waiting times make it possible for the respective component to be left in the switched-off condition as long as possible, whereby the power consumption of the receiving unit can be further reduced.

The method of controlling the receiving unit is such that it can be implemented in the IEEE 802.11a standard as a level between the physical protocol level and the MAC level. Alternatively however it can also be integrated into the physical level or MAC level or it can be distributed to both levels.

Embodiments by way of example of the present invention are described in detail hereinafter with reference to the accompanying drawings.

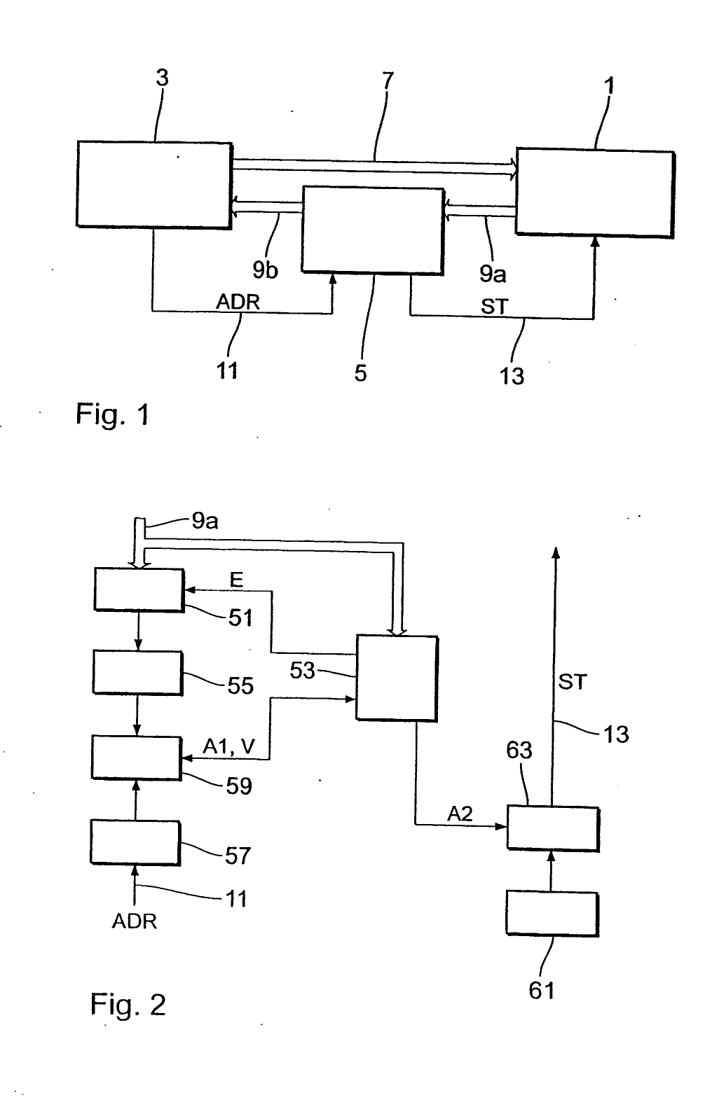

FIG. 1 shows the block circuit diagram of a portion of a communication unit according to the invention,

FIG. 2 shows a first embodiment of the control unit shown in FIG. 1,

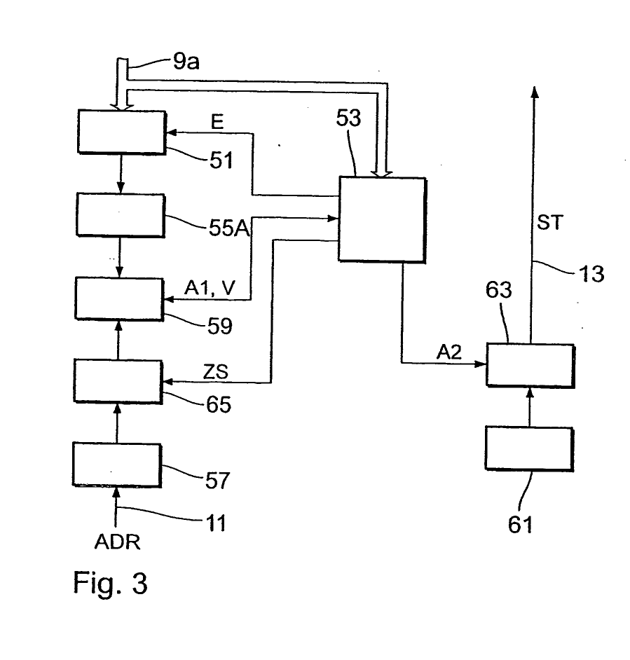

FIG. 3 shows a second embodiment of the control unit shown in FIG. 1, and

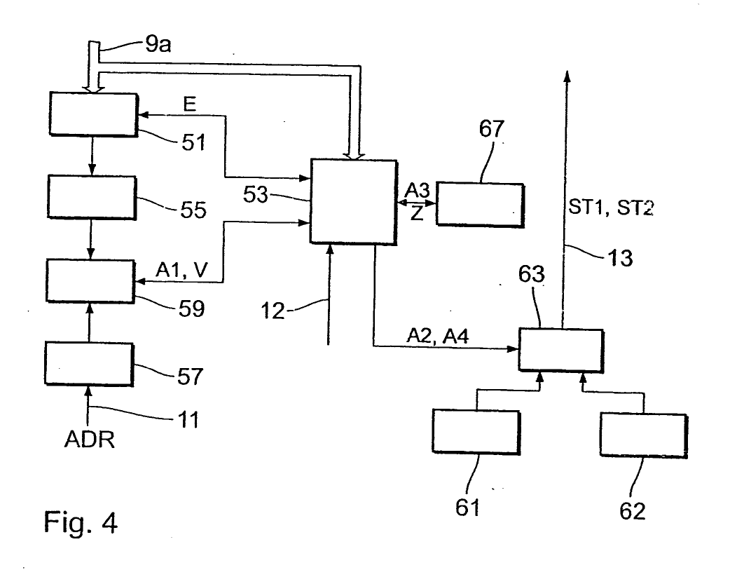

FIG. 4 shows a third embodiment of the control unit shown in FIG. 1.

FIG. 1 shows the block circuit diagram of a portion of a communication unit according to the invention for communicating in a wireless network. The communication unit which is described hereinafter by way of example with reference to the IEEE 802.11a standard but which is not limited thereto includes a receiving unit which here is in the form of a transmitting/receiving unit 1, and a unit for access to the transmission medium 3, referred to briefly as the MAC unit (Medium Access Control).

The transmitting/receiving unit represents the physical level, the lowermost protocol level in the IEEE 802.11a standard. It corresponds to the physical level in the ISO reference model, a standard for communication protocol architectures. The physical level establishes the hardware parameters of the transmission such as transmission speed, transmitting power, transmission medium, interfaces etc. For that purpose, besides the transmitter/receiver, the transmitting/receiving device includes inter alia for example a Viterbi decoder and a device for fast Fourier transformation, referred to hereinafter briefly as the FFT device (East Fourier Transformation).

The MAC unit 3 represents the next higher level in the IEEE 802.11a standard, following the physical level. In the ISO reference model the MAC level is a constituent of the data communication level. The MAC level is a protocol level which is responsible for the order being maintained when using the common transmission medium. For that purpose it includes a device for executing the so-called protocol for multiple access with collision avoidance, referred to briefly as the CSMA/CA protocol (carrier sense multiple access with collision avoidance), and a device for executing cyclic block checking, referred to briefly as CRC (cyclic redundancy check)—a procedure for checking data packets for transmission errors.

The data packets to be sent by the communication unit are transferred by the MAC unit by way of a first data bus 7, the transmitting data path, to the transmitting/receiving unit 1, and transmitted thereby. Data packets received by the transmitting/receiving unit 1 are transferred to the MAC unit 3 by way of a second data bus 9a, 9b, the receiving data path.

In all data packets in accordance with the IEEE 802.11a standard the first 10 bytes are of the same structure. The first two bytes contain items of information about the nature of the packet, the third and the fourth bytes in by far most cases contain time details which are relevant for sending the next data packet. The address of the communication unit for which the data are intended, that is to say the target address, is contained at least in the fifth to tenth bytes.

In accordance with the invention, disposed in the receiving data path 9a, 9b is a control unit 5 for acting on the transmitting/receiving unit 1, in particular for interrupting processing of the data packet. The control unit 5, by way of the data bus 9a, receives the signal received by the transmitting/receiving unit 1, and forwards it to the MAC unit 3 by way of the data bus 9b. The control unit 5 is also connected by way of an address signal line 11 to the MAC unit 3 and by way of a control signal line 13 to the transmitting/receiving unit 1.

The control unit 5 serves to break off processing of a data packet in the transmitting/receiving unit 1 when it establishes that the target address in the data packet is not in conformity with the address of the receiving communication unit. For that purpose the control unit 5 compares the address of the communication unit (referred to hereinafter as the MAC address) which it receives from the MAC unit 3 by way of the address signal line 11 to the target address which comes in by way of the data bus 9a. The control unit 5 interrupts processing by switching off (deactivating) components of the transmitting/receiving unit 1 as soon as it establishes that the MAC address is not in conformity with the target address. In an embodiment of the invention the switched-off components are switched on again by the receiver of the transmitting/receiving unit 1 as soon as the receiver registers the arrival of the next data packet. In that way, in that embodiment of the invention, all components of the transmitting/receiving unit 1 except the receiver can be switched off. In particular the Viterbi decoder or the FFT device for fast Fourier transformation are considered as components which are switched off.

In an alternative configuration of the control unit 5 according to the invention the receiver is also switched off (deactivated). The control unit 5 switches on at least the receiver and possibly also the other switched-off components of the transmitting/receiving unit 1 again after a given waiting time has elapsed. That waiting time is calculated by the control unit 5 on the basis of the length of the data packet, the transmission rate at which transmission is effected and possibly a delay time, which is predetermined by the transmission standard used, between the transmission of two successive data packets, so that the receiver is ready to receive again as soon as a new data packet can enter. The transmission rate for example in the IEEE 802.11a standard is between 6 and 54 Mbps (Megabits per second), wherein the standard prescribes that the communication units must support at least transmission rates of 6, 12 and 24 Mbps. With a transmission rate of for example 6 Mbps and a data packet length of 750 bytes the transmission duration for the data packet is 1 ms. After 1 ms, possibly plus a delay time, predetermined by the transmission standard used, between the transmission of two successive data packets, the receiver in the selected example must therefore be ready to receive again. Calculation of the waiting time after which the receiver must be switched on again in order to be ready to receive again when the data packet arrives may also include apparatus-specific parameters such as for example the duration of the switching-on and switching-off procedure in respect of the individual hardware components. Calculation of the waiting time is described in greater detail in connection with the third embodiment (FIG. 4). The apparatus-specific parameters are communicated to the control unit 5 by the MAC unit 3 by way of a further signal line (not shown in FIG. 1).

The transmitting and the receiving data paths are shown in FIG. 1 as two separate, unidirectional data buses 7 and 9a, 9b respectively. They may however also be embodied by a single bidirectional data bus, in which case the control unit is then disposed in that bidirectional data path. In this case, instead of being transmitted by way of signal lines, the MAC address and the apparatus-specific parameters can also be transmitted by way of the bidirectional data path.

FIG. 2 shows a first embodiment of the control unit 5 according to the invention in the form of a block circuit diagram. In this embodiment the control unit 5 includes a signal input 51 to which the received data are passed by way of the data bus 9a. The signal input 51 is connected to a first register 55 which in turn is connected to a comparator 59. The comparator 59 is also connected to a second register 57, to which the MAC address can be transmitted by way of the address signal line 11. The first register 55, the second register 57 and the comparator 59 form a comparison device for comparing the target address to the MAC address. An operational control arrangement 53 to which the received data are also passed by way of the data bus 9a is connected by way of control lines to the signal input 51, the comparator 59 and a read-out unit 63. The read-out unit 63 is further connected to a first memory 61 in which the stop signal for interrupting processing and switching off (deactivating) the components of the transmitting/receiving unit 1 is stored, and in response to a triggering signal A2 sent by the control unit 53, can deliver the stop signal as a control signal ST by way of the control signal line 13 to the transmitting/receiving unit 1. The control unit 53 outputs the triggering signal A2 if the comparator 59 establishes that the contents stored in the first and second registers 55, 57 are not coincident. The received data packet is also forwarded to the MAC unit 3 by way of a connection (not shown in FIG. 2) present between the data bus 9a and the data bus 9b.

The mode of operation of the control unit 5 shown in FIG. 2 will now be described in greater detail. At the beginning the control unit 5 is in the waiting condition. As soon as the operational control arrangement 53 detects the input of a data packet, a counter which at the beginning of the waiting condition was set to zero begins to count the incoming bits synchronously with the data transmission rate. After the first four bytes of a data packet, that is to say the first 32 bits of the packet are received, the operational control arrangement 53 outputs an enable signal E to the signal input 51. It is to be noted in this respect that the enable signal E is applied to the signal input before the 33rd bit of the data packet arrives at the control unit 5. This is achieved by the control unit 5 being controlled at a clock rate which is higher than the data transmission rate. Advantageously, the clock rate is a multiple of the transmission rate. The enable signal E causes the signal input 51 to write into the first register the bits which now follow, that is to say the incoming target address (bits 33 to 80, that is to say bytes 5 to 10). When then the counter reaches the value 80 the operational control arrangement 53 takes the enable signal E back so that, after the arrival of the 80 bits, but still prior to the arrival of the 81st bit, the operation of writing into the first register 55 is ended. At the same time the operational control arrangement 53 outputs a triggering signal A1 to the comparator 59. In response to the triggering signal A1 the comparator 59 implements a comparison of the content of the first register 55 with the content of the second register 57 which contains the MAC address and outputs a comparison signal V to the operational control arrangement 53. The comparison signal V specifies whether the contents of the two registers 55, 57 are the same or not.

If the comparison signal V indicates that the target address is not in conformity with the MAC address, the operational control arrangement 53 causes the read-out unit 63, by means of a second triggering signal A2, to output the stop signal stored in the first memory 61 as a control signal ST by way of the control signal line 13 to the transmitting/receiving unit 1. After the stop signal is outputted the operational control arrangement 53 puts the control unit 5 into the waiting condition again, with the counter being reset to zero.

If in contrast the comparison signal V indicates that the content of the first register 55 is in conformity with that of the second register 57 and thus the target address is in conformity with the MAC address, then the operational control arrangement 53 puts the control unit 5 into the waiting condition again, without causing the output of the stop signal, so that the receiving unit 1 processes the entire data packet. In addition it resets the counter to zero.

A modified embodiment of the control unit shown in FIG. 2 is illustrated in FIG. 3. The modified embodiment differs from the embodiment illustrated in FIG. 2, in terms of the configuration of the comparison device. In the modified comparison device the first register is in the form of a one-bit register 55A into which the signal input 51 writes each individual bit of the incoming target address. In that case, in each writing operation, the bit written into the one-bit register 55A in the respective preceding writing operation is overwritten. In addition, the modified comparison device, between the second register 57 and the comparator 59, has an access unit 65, by means of which it is possible to access the content of each individual memory cell in the second register 57. That access unit 65 is connected to the operational control arrangement 53. In other respects the embodiment shown in FIG. 3 does not differ from that illustrated in FIG. 2.

As in the first embodiment the control unit 5 is in the waiting condition until the operational control arrangement 53 detects the input of a data packet. At the input of a data packet, counting of the incoming bits begins, as in the first embodiment. After the 32nd bit is received the operational control arrangement 53 outputs an enable signal E to the signal input 51. Thereupon the signal input 51 writes the incoming bits into the one-bit register 55A synchronously with the transmission rate, wherein in each writing operation the preceding content of the one-bit register 55A is overwritten. In this embodiment also the clock rate of the control unit 5 is higher than the transmission rate. In addition the operational control arrangement 53, with the input of the 32nd bit, begins for each incoming bit of the target address to output an access control signal ZS to the access unit 65. That access control signal ZS causes the access unit 65 to access the respective bit of the MAC address, which is stored in the second register 57 and in its value corresponds to that of the bit which is just being written into the one-bit register 55A, in the target address. In addition, for each bit of the target address, which is written into the one-bit register 50A, the operational control arrangement 53 outputs a triggering signal A1 to the comparator 59. Thereupon the comparator 59 compares the content of the one-bit register 50A, that is to say the target address bit stored there, to the bit of the second register selected by the access unit 65 in response to the access control signal ZS. That is repeated for each incoming bit of the target address, that is to say 48 times with an address length of 48 bits. In that way the incoming target address is compared bit-wise to the stored MAC address.

If, in one of the comparison operations, the comparator establishes that the target address bit stored in the one-bit register 55A is not in conformity with the MAC address bit corresponding thereto in respect of its value, then the operational control arrangement 53 recognizes that from the value of the comparison signal V and triggers off interruption of processing. The operational control arrangement 53 for that purpose outputs a triggering signal A2 to the read-out unit 63, whereupon it reads out the stop signal stored in the first memory 61 and outputs it as a control signal ST by way of the control signal line 13 to the transmitting/receiving unit 1 in order to break off processing and switch off components of the transmitting/receiving unit 1. Thereafter the operational control arrangement 53 puts the control unit 5 back into the waiting condition with the counter for the incoming bits being reset to zero.

If in contrast, for each bit of the incoming target address, the comparator 59 establishes identity with the MAC address bit which corresponds in respect of its value, the operational control arrangement 53 terminates the comparison operation after the last bit of the target address (in the IEEE 802.11a standard this is the 80th bit) is received, without the control unit 5 outputting a stop signal to the transmitting/receiving unit 1 as the target address and the MAC address are in conformity. The operational control arrangement therefore puts the control unit 5 back into the waiting condition without breaking off processing and in that way permits the entire data packet to be received.

In the embodiments set forth hereinbefore the receiver was not switched off when processing was interrupted because the receiver was required to switch on the switched-off components of the transmitting/receiving unit 1 again.

A further embodiment of the control unit 5 according to the invention is shown in FIG. 4. In this embodiment the control unit 5 also switches off the receiver if it establishes that the target address is not in conformity with the MAC address. In that case however it has to switch the receiver on again in good time to receive the next data packet. That is possible with the embodiment illustrated in FIG. 4. Besides the receiver, further components of the transmitting/receiving unit 1 can also be switched off. The control unit 5 then switches on again either all switched-off components or initially only the receiver. In the latter case the other components are switched on again by the receiver, upon reception of the next data packet. The information as to which components the control unit 5 switches off and which components it then switches on again and when, is contained in the stop signal and in a start signal respectively. It is also possible for various components to each have their own respective stop and in particular start signals.

The embodiment illustrated in FIG. 4 differs from the embodiment shown in FIG. 1 by a second memory 62 which is connected to the read-out unit 63 and which stores a start signal for switching on the receiver, and a calculation unit 67 for calculating a waiting time which is to elapse before the control unit 5 switches the receiver of the transmitting/receiving unit 1 on again. Calculation of the waiting time also involves apparatus-specific parameters of the transmitting/receiving unit 1, for example the duration of the switching-on process of the receiver. In the preferred embodiment the operational control arrangement 53 obtains those parameters by way of an additional signal line 12 from the MAC unit 3. They can however also be stored in the control unit 5 or possibly transmitted by way of the data path. The parameters are forwarded to the calculation unit 67 by the operational control arrangement 53.

The calculation unit 67 calculates the waiting time on the basis of the data rate at which the data are received, the length of the incoming data packet, the delay time which is predetermined by the transmission standard used between the transmission of two successive data packets, and optionally apparatus-specific parameters. The operational control arrangement 53 transmits the corresponding values to the calculation unit 67 prior to the beginning of comparison of the target address with the MAC address. In that way the waiting time can already be calculated after input of the information about the length of the data packet. The transmission parameters required for the calculation are generally already known before the target address is received.

Multiplication of the transmission rate by the length of the data packet gives the time required for transmission of the data packet, that is to say the transmission duration of the incoming data packet. The calculation unit 67 also adds to the transmission duration the delay time, which is predetermined by the transmission standard used, between the transmission of two successive data packets. The resulting time duration specifies how much time may elapse until the receiver has to be ready to receive again. When ascertaining the waiting time, account is also to be taken of the fact that the operation of switching on the receiver requires a certain amount of time. When ascertaining the waiting time therefore, the calculation unit 67 subtracts at least the time required for switching on the receiver from the time which may elapse before the receiver has to be ready to receive again. The calculation unit 67 finally outputs the waiting time calculated in that way to the operational control arrangement 53. Desirably the time which is required for switching on the receiver is predetermined as an apparatus-specific parameter. In that way the period of time to the subtracted can be minimized. The duration of the switching-on operation can also be predetermined as an apparatus-specific parameter, for the other switched-off components.

The operational control arrangement 53 triggers calculation of the time duration by a third triggering signal A3 which it outputs to the calculation unit 67 simultaneously with the output of the second triggering signal A2 for triggering the step of breaking off reception, to the read-out unit 63. That ensures that the waiting time is only calculated when reception is actually broken off. Alternatively however the waiting time can also be calculated for each incoming data packet so that the waiting time is already known prior to the decision about breaking off reception and thus at as early a time as possible. After it has been calculated, the calculation unit 67 outputs the waiting time to the operational control arrangement 53. With the expiry of the waiting time the operational control arrangement 53 then outputs a further fourth triggering signal A4 to the read-out unit 63. That fourth triggering signal A4 causes the read-out unit 63 to read out a start signal stored in the second memory 62 and output it to the transmitting/receiving unit 1, whereupon the receiver and optionally further components of the transmitting/receiving unit 1 are switched on again.

Switching the receiver on and off, as described in relation to the third embodiment in which comparison of the addresses takes place only after complete input of the target address, is equally possible if the addresses are compared in bit-wise manner, as has been described in relation to the second embodiment.

The illustrated embodiments only serve to describe the invention and not to limit it. Numerous modifications are possible within the scope of the accompanying claims, some of those embodiments being described by way of example hereinafter.

All embodiments provide that only one MAC address was compared to the target address in each case. It is however also possible for a plurality of addresses, for example an address list, to be compared to the target address. For that purpose, the control unit can be of a specially adapted structure, for example it may have a plurality of parallel registers or a multi-component register. Processing of the data packet is then not broken off when at least one of the addresses from the address list is in conformity with the target address. Alternatively, it is also possible for processing not to be broken off only when a given minimum number of addresses on the address list are in conformity with the target address.

The control unit which, in the described embodiments, is illustrated between the transmitter/receiver embodying the physical level of the IEEE 802.11a protocol, and the MAC unit embodying the next higher protocol level, can be embodied within the protocol architecture both in the physical level and also in the MAC level, as long as comparison of the target address with the MAC address is effected before the data packet is completely processed. Advantageously address comparison is effected as early as possible in the receiving procedure.

Instead of bit-wise comparison of the target address with the MAC address and comparison of the complete addresses, all intermediate forms such as for example byte-by-byte comparison are also possible.

Besides the receiver, it is also possible to ascertain for all other components of the transmitter/receiver, respective individual waiting times, after which they are switched on again. If the waiting time is only ascertained for the receiver, the control unit can be so designed that it switches on the other components again either together with the receiver or in succession. If the control unit only switches on the receiver again, the other components are switched on again by the receiver, for example upon the reception of a fresh data packet.

Instead of a transmitting/receiving unit, the assembly may also have mutually independent transmitting and receiving units. In that case the control unit only needs to be able to deliver signals to the receiving unit.

The stop signal and the start signal do not need to be stored in a first and a second memory respectively in the control unit. Alternatively for example they can be stored in the MAC unit and can be outputted by the MAC unit to the transmitting/receiving unit either by way of the control unit or directly, at the instigation of the operational control arrangement.

Besides being used in systems with wireless data transmission, the reception control according to the invention can also be used in those systems for wired data transmission, in which the target address is first checked in the receiver.

1. A control unit for controlling a receiving unit (1) for receiving data packets which include a target address, comprising a signal input (51) adapted to receive the target address, a comparison device (55, 57, 59) for comparing the target address to at least one predetermined address and an output unit (63) for outputting a control signal (ST) which at least partially switches off the receiving unit (1) and thus breaks off processing of the data packet if the target address and the predetermined address are not in conformity.

2. A control unit as set forth in claim 1 wherein the comparison device (55, 57, 59) is adapted for a comparison of the complete target address with the complete predetermined address.

3. A control unit as set forth in claim 1 wherein the comparison device (55, 57, 59) is adapted for a comparison of parts of the target address with parts of the predetermined address.

4. A control unit as set forth in claim 3 wherein the comparison device (55, 57, 59) is adapted for bit-wise comparison of the target address with the predetermined address.

5. A control unit as set forth in one of claims 1 through 4 in which the comparison device includes a comparator (59), a first register (55) connected to the comparator (59) for storing the target address and a second register (57) connected to the comparator (59) for storing the predetermined address, and in which the comparator (59) is adapted for comparison of the contents of the two registers (55, 57).

6. A control unit as set forth in claim 5 wherein the first register is in the form of a one-bit register (55A) for time-limited storage of the incoming bits of the target address, wherein the comparison device includes an access unit (65) for access to individual memory cells of the second register (57), and wherein the comparator (59) is adapted for comparing the content of the one-bit register (55A) to the content of that memory cell of the second register (57), to which access is effected by the access unit (65).

7. A control unit as set forth in one of the preceding claims wherein the receiving unit (1), besides a receiver, includes at least one further component and wherein the control signal (ST) is such that all components except for the receiver are switched off for partially switching off the receiving unit (1).

8. A control unit as set forth in one of claims 1 through 6 wherein the receiving unit (1), besides a receiver, includes at least one further component and wherein the control signal (ST) is such that at least the receiver is switched off for partially switching off the receiving unit (1) and which also includes a switch-on device (62, 63, 67) for switching on at least the receiver again.

9. A control unit as set forth in claim 8 including a calculation unit (67) for calculating a waiting time, after which the switch-on device (62, 63, 67) switches on at least the receiver again.

10. A control unit as set forth in one of the preceding claims wherein the comparison unit (55, 57, 59) is adapted for comparing the target address to a plurality of predetermined addresses and wherein the output unit (63) is so adapted that it outputs the control signal for at least partially switching off the receiving unit (1) if none of the predetermined addresses is in conformity with the target address.

11. A communication unit for wireless communication including a receiving unit and a control unit (5) as set forth in one of claims 1 through 10, the control unit being connected to the receiving unit by way of a control signal line (13).

12. A communication unit as set forth in claim 11 which additionally includes an MAC unit (3) which contains the at least one predetermined address and is connected to the control unit (5) by way of an address signal line (11).

13. A communication unit as set forth in claim 11 or claim 12 which additionally includes a transmitting unit and in which the MAC unit (3) is connected to the transmitting unit by way of a transmitting data path (7) and to the receiving unit by way of a receiving data path (9a, 9b), the control unit (5) being arranged in the receiving data path.

14. A communication unit as set forth in claim 13 wherein the transmitting unit and the receiving unit are embodied by a combined transmitting/receiving unit (1), the transmitting data path (7) and the receiving data path (9a, 9b) are embodied by a single bidirectional data path and the control unit (5) is arranged in the bidirectional data path.

15. A communication unit as set forth in claim 14 wherein the control signal line. (13) and/or the address signal line (11) are integrated into the bidirectional data path.

16. A method of controlling a receiving unit (1) for receiving data packets which include a target address, comprising the steps:
receiving the target address of the incoming data packet,
comparing the target address to at least one predetermined address before the data packet is completely processed by the receiving unit (1), and
at least partially switching off the receiving unit (1) without waiting for complete processing of the data packet as soon as the comparison reveals that at least one of the predetermined addresses is not in conformity with the target address.

17. A method as set forth in claim 16 wherein the receiving unit (1) is partially switched off only when none of the predetermined addresses is in conformity with the target address.

18. A method as set forth in claim 16 or claim 17 wherein a receiving unit (1) including a receiver and at least one further component is partially switched off by at least the receiver being switched off.

19. A method as set forth in claim 18 with the additional steps:
calculating a waiting time after which at least the receiver is to be switched on again, and
switching on at least the receiver on the expiry of the waiting time.

20. A method as set forth in claim 19 wherein the waiting time is calculated by means of the length of the data packet to be received and the transmission rate at which the data packet is transmitted.

21. A method as set forth in claim 19 or claim 20 wherein calculation of the waiting time involves a delay time between the transmission of two successive data packets and/or apparatus-specific parameters.

22. A method as set forth in claim 21 wherein calculation of the waiting time involves the duration of the switch-on process for switching on the receiver.

23. A method as set forth in one of claims 18 through 22 in which besides the receiver still further components of the receiving unit (1) are switched off, upon the expiry of the waiting time only the receiver is switched on again, and the receiver then switches on the other components again at the beginning of reception of the next data packet.

24. A method as set forth in one of claims 18 through 22 in which besides the receiver still further components of the receiving unit (1) are switched off and after expiry of the waiting time all components are switched on again by the control unit (5).

25. A method as set forth in one of claims 18 through 22 wherein besides the receiver still further components of the receiving unit (1) are switched off, for each switched-off component a respective individual waiting time is calculated, and each component is switched on again by the control unit (5) after the expiry of its individual waiting time.

26. A method as set forth in one of claims 16 through 25 wherein the method is performed in accordance with the IEEE 802.11a standard.
